(19) United States
(12) Patent Application Publication
(10) Pub. No.: US 2026/0251954 A1
(43) Pub. Date: Aug. 27, 2026

(54) OPERATION METHOD OF ELECTRONIC DEVICE AND ELECTRONIC DEVICE FOR PERFORMING THE SAME

(71) Applicant: AGENCY FOR DEFENSE DEVELOPMENT, Daejeon (KR)

(72) Inventors: Ji Hun BAE, Daejeon (KR); Jeong Seok KIM, Daejeon (KR); Jun Wha HONG, Daejeon (KR)

(21) Appl. No.: 19/343,203

(22) Filed: Sep. 29, 2025

(30) Foreign Application Priority Data
Feb. 27, 2025 (KR) 10-2025-0026132

(51) Int. Cl. G03B 13/36; G02B 7/10; G06T 3/40; G06T 7/70; G06T 11/60; H04N 23/61; H04N 23/67

(52) U.S. Cl. CPC G03B 13/36; G02B 7/102; G06T 3/40; G06T 7/70; G06T 11/60; H04N 23/61; H04N 23/67

(57) ABSTRACT

An electronic device of the disclosure includes an optical part including a plurality of lenses, a driving part including a first electroactive material, one or more processors, and a memory storing one or more programs for execution by the processor, the one or more programs including instructions for identifying a target object in a first image captured through the optical part, determining, based on information on the target object, correction information that includes at least one of shift information for adjusting a position of the target object in the first image and magnification information for adjusting a size of the target object in the first image, and determining a control signal for physical deformation corresponding to the correction information of the first electroactive material. Here, the plurality of lenses may be adjusted based on physical deformation of the first electroactive material.

### PRIORITY INFORMATION

This application claims the benefit of Korean Patent Application No. 10-2025-0026132, filed on Feb. 27, 2025, in the Korean Intellectual Property Office, the disclosure of which is incorporated herein by reference in its entirety.

### FIELD OF INVENTION

The disclosure relates to systems, devices, methods, and instructions for operation of an electronic device.

### DISCUSSION OF RELATED ART

In a device such as a drone equipped with an infrared camera, a flight time during a terminal tracking phase to catch up a target may be as short as several to several tens of milliseconds. In a case of an infrared camera that includes a zoom optical system to which a general commercial motor is applied for a field-of-view variation, there may be an issue that detection performance and tracking performance may not be maximized since the field-of-view variation and tracking and catching up a target within the flight time in a very short terminal tracking phase are not possible due to a limitation of motor performance.

### SUMMARY OF THE INVENTION

Accordingly, the example embodiments are directed to systems, devices, methods, and instructions for operation of an electronic device that substantially obviate one or more problems due to limitations and disadvantages of the related art.

The disclosed example embodiments provide an electronic device that includes a driving part including an electroactive material, and an operation method of an electronic device. A technical task to be achieved by an example embodiment of the disclosure is not limited to the technical task described above, and other technical tasks may be derived from example embodiments described below.

As a technical solution for achieving the above-described task, an electronic device according to an aspect of the disclosure may include an optical part including a plurality of lenses, a driving part including a first electroactive material, one or more processors, and a memory storing one or more programs for execution by the processor, the one or more programs including instructions for identifying a target object in a first image captured through the optical part, determining, based on information on the target object, correction information that includes at least one of shift information for adjusting a position of the target object in the first image and magnification information for adjusting a size of the target object in the first image, and determining a control signal for physical deformation corresponding to the correction information of the first electroactive material. Here, the plurality of lenses may be adjusted based on physical deformation of the first electroactive material.

According to an example embodiment, the electronic device may further include an energy generation part that collects electrical energy generated as a second electroactive material reacts to an external stimulus.

According to an example embodiment, the first electroactive material may include a dielectric elastomer-based electroactive polymer, and the second electroactive material may include a ferroelectric polymer-based electroactive polymer.

According to an example embodiment, the one or more processors may identify the target object among a plurality of objects included in the first image based on position information and class information of the plurality of objects.

According to an example embodiment, the information on the target object may include information on the position of the target object in the first image and may be information for adjusting the position of the target object in the first image to a central position in the first image.

According to an example embodiment, the information on the target object may include information on the size of the target object in the first image, and the magnification information may be information for adjusting the size of the target object in the first image to a set size.

According to an example embodiment, the electronic device may further include an electrical energy storage part that stores electrical energy collected from the energy generation part. Here, the one or more processors may control, by transmitting the control signal to the electric energy storage part, an electrical signal corresponding to the control signal to be applied to the driving part.

According to an example embodiment, as the electrical signal is applied to the driving part, a shape of the first electroactive material may be deformed to correspond to a magnitude of the electrical signal. In addition, positions of the plurality of lenses may be adjusted from a first position to a second position to have a field of view corresponding to the correction information as the shape of the first electroactive material is deformed.

According to an example embodiment, the one or more processors may identify, in response to a set time elapsing from a point in time at which the control signal is determined, the target object in a second image captured by the optical part including the plurality of lenses corresponding to the second position.

According to an example embodiment, as the positions of the plurality of lenses are adjusted from the first position to the second position, the first image may be changed to a third image. The third image may be used for training data of an artificial intelligence model for object detection.

According to another aspect of the disclosure, an operation method of an electronic device that includes an optical part including a plurality of lenses, a driving part including a first electroactive material, one or more processors, and a memory, may include identifying a target object in a first image captured through the optical part, determining, based on information on the target object, correction information that includes at least one of shift information for adjusting a position of the target object in the first image and magnification information for adjusting a size of the target object in the first image, and determining a control signal for physical deformation corresponding to the correction information of the first electroactive material. Here, the plurality of lenses may be adjusted based on physical deformation of the first electroactive material.

According to another aspect of the disclosure, a non-transitory computer-readable recording medium comprising a computer program for performing an operation method of an electronic device that includes an optical part including a plurality of lenses, a driving part including a first electroactive material, one or more processors, and a memory, the operation method may include identifying a target object in a first image captured through the optical part, determining, based on information on the target object, correction information that includes at least one of shift information for adjusting a position of the target object in the first image and magnification information for adjusting a size of the target object in the first image, and determining a control signal for physical deformation corresponding to the correction information of the first electroactive material. Here, the plurality of lenses may be adjusted based on physical deformation of the first electroactive material.

It is to be understood that both the foregoing general description and the following detailed description are examples and explanatory and are intended to provide further explanation of the invention as claimed.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating an electronic device for performing an operation method of the electronic device according to an example embodiment;

FIG. 2 is a diagram for describing an operation method of an electronic device according to an example embodiment;

FIG. 3 is a diagram for describing a method of identifying a target object among a plurality of objects included in a first image according to an example embodiment;

FIG. 4 is a diagram for describing a first image including an identified target object according to an example embodiment;

FIG. 5 is a diagram for describing a third image obtained as positions of a plurality of lenses are adjusted from a first position to a second position according to an example embodiment;

FIG. 6 is a diagram for describing physical deformation of a first electroactive material according to an example embodiment;

FIG. 7 is a diagram for describing an example in which distances between a plurality of lenses are changed as physical deformation occurs in a first electroactive material according to an example embodiment; and

FIG. 8 is a flowchart illustrating an operation method of an electronic device according to an example embodiment.

### DETAILED DESCRIPTION OF THE EXAMPLE EMBODIMENTS

Reference will now be made in detail to the embodiments of the invention, examples of which are illustrated in the accompanying drawings.

Terms used in the example embodiments are selected, as much as possible, from general terms that are widely used at while taking into consideration the functions obtained in accordance with the disclosure, but these terms may be replaced by other terms based on intentions of those skilled in the art, customs, emergence of new technologies, or the like. Also, in a particular case, terms that are arbitrarily selected by the applicant of the disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when a component is referred to as “including” another component, the component should not be understood as excluding other components so long as there is no special conflicting description, and the element may include at least one other component. In addition, the terms “unit” and “module”, for example, may refer to a component that exerts at least one function or operation, and may be realized in hardware or software, or may be realized by combination of hardware and software.

The expression “at least one of A, B, and C” may indicate the following meaning including: A alone; B alone; C alone; both A and B together; both A and C together; both B and C together; or all three of A, B, and C together.

In the disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example embodiments of the disclosure will be described in detail with reference to the drawings so that those skilled in the art can readily carry out the disclosure. However, the disclosure may be embodied in many different forms and is not limited to the embodiments described herein.

In describing the example embodiments, descriptions of technical contents that are well known in the art to which the disclosure belongs and are not directly related to the specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the disclosure and methods of achieving them will be apparent from the following example embodiments that will be described in more detail with reference to the accompanying drawings. It should be noted, however, that the disclosure is not limited to the following example embodiments, and may be implemented in various forms. Accordingly, the example embodiments are provided only to disclose the disclosure and let those skilled in the art know the category of the disclosure, and the disclosure is only defined by the category of claims. The same reference numerals or the same reference designators denote the same components throughout the specification.

At this point, it will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus computer program instructions stored in the computer usable or computer readable memory can produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

The following description of example embodiments disclosed in the disclosure is provided with reference to the accompanying drawings.

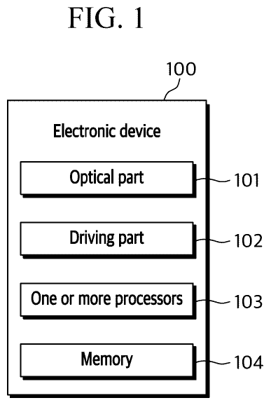

FIG. 1 is a block diagram illustrating an electronic device for performing an operation method of an electronic device according to an example embodiment.

An electronic device 100 of FIG. 1 may be a device for performing an operation method of an electronic device. According to an example embodiment, the electronic device 100 may include an optical part 101, a driving part 102, one or more processors 103, and a memory 104. According to the electronic device 100 illustrated in FIG. 1, only components related to the example embodiment are illustrated. Accordingly, it will be understood by those skilled in the art that, in addition to the components illustrated in FIG. 1, other general-purpose components may also be included. In the present specification, the electronic device 100 may be a device for performing an object detection task in real time. For example, the electronic device 100 may be an unmanned aerial vehicle (UAV), such as a drone, but is not limited thereto.

In the present specification, a target object may be an object to be a target of detection by the electronic device 100. When the electronic device 100 is a UAV related to national defense, the target object may be an object related to an enemy weapon system, but is not limited thereto.

The optical part 101 may be a zoom optical system that performs a role of processing a light source, and includes a plurality of lenses. When positions of the plurality of lenses, which include arrangements of the plurality of lenses and angles of the plurality of lenses included in the optical part 101, are adjusted, a position or size of an object in an image may be changed.

The driving part 102 may be a device for adjusting the positions of the plurality of lenses included in the optical part 101. More specifically, as an electrical signal (for example, a voltage) is applied to the driving part 102, physical deformation may occur in a first electroactive material included in the driving part 102. Here, the physical deformation may refer to dynamic deformation of a shape of the first electroactive material and include extension, contraction, and folding of the first electroactive material. As the shape of the first electroactive material is deformed, the positions of the plurality of lenses may be adjusted.

In the present specification, the first electroactive material may include an electroactive polymer of which a maximum deformation rate is a set value or greater. As an example, the first electroactive material may include a dielectric elastomer-based electroactive polymer. The first electroactive material that includes the dielectric elastomer-based electroactive polymer may be characterized by having a large deformation rate (for example, a maximum deformation rate of 380%). As another example, the first electroactive material may be a polymer of the dielectric elastomer-based electroactive polymer and a ferroelectric polymer-based electroactive polymer, in which a proportion of the dielectric elastomer-based electroactive polymer is higher.

The one or more processors 103 may control overall operations of the electronic device 100 and process data and signals. The one or more processors 103 may perform the operation method of an electronic device that will be described below through FIGS. 1 to 8. The one or more processors 103 may include at least one hardware unit. In addition, the one or more processors 103 may be operated by one or more software modules generated by executing one or more instructions stored in the memory 104. The one or more processors 103 may control the optical part 101, the driving part 102, the memory 104, and example embodiments performed by the electronic device 100 through interaction with components that may be further included in the electronic device 100. The one or more processors 103 according to an example embodiment may perform an operation related to detecting and tracking of the target object by executing the one or more instructions stored in the memory 104. More specifically, the one or more processors 103 may perform an operation of identifying the target object by using an artificial intelligence model and an operation of determining correction information, and may determine a control signal for allowing proper physical deformation to occur in the first electroactive material.

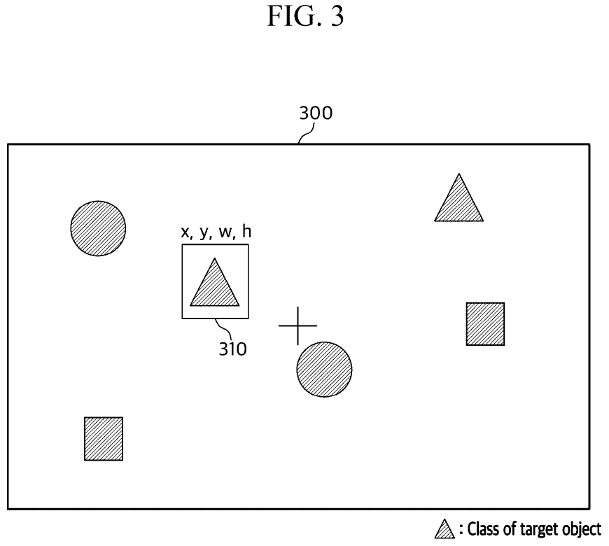

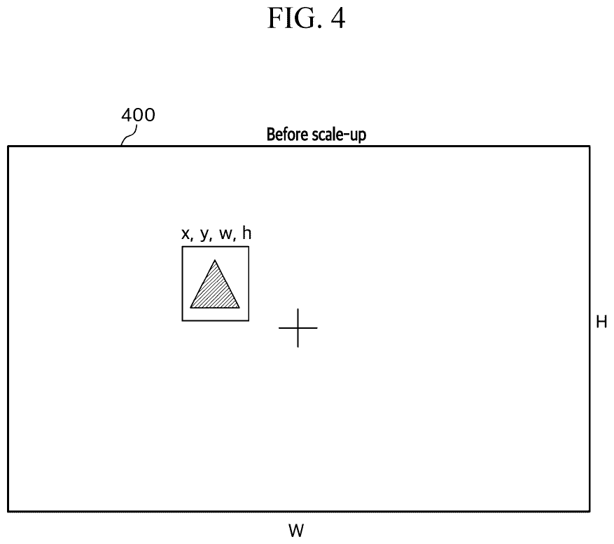

According to an example embodiment, the one or more processors 103 may identify a target object in a first image captured through the first optical part 101. Before identifying the target object, the one or more processors 103 may perform various preprocessing tasks that include noise removal and brightness and contrast adjustment for the first image captured through the optical part 101. The one or more processors 103 may identify the target object in the first image after the preprocessing tasks are performed. By processing an image at a high frame rate, the one or more processors 103 may identify the target object moving at a high speed in real time in the first image. An operation of the electronic device 100 identifying the target object will be described in more detail with reference to FIGS. 3 and 4.

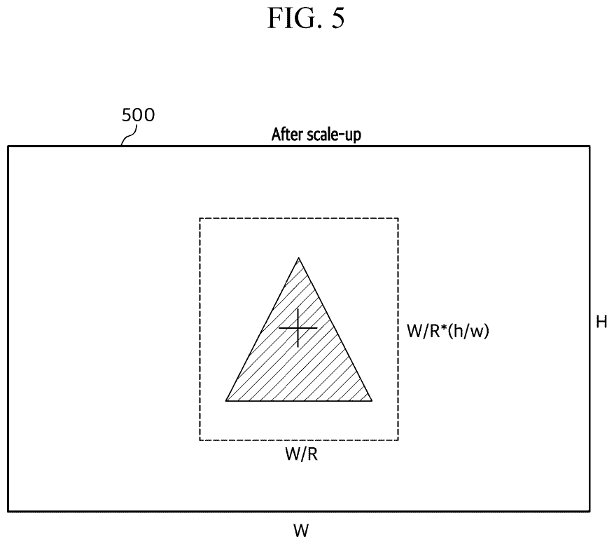

According to an example embodiment, the one or more processors 103 may determine, based on information on the target object, correction information that includes at least one of shift information for adjusting a position of the target object in the first image and magnification information for adjusting a size of the target object in the first image. An operation of the electronic device 100 determining the correction information will be described in more detail with reference to FIGS. 4 and 5.

According to an example embodiment, the one or more processors 103 may determine the control signal for the physical deformation corresponding to the correction information of the first electroactive material. When the electrical signal corresponding to the control signal is applied to the driving part 102, the physical deformation may occur in the first electroactive material. The plurality of lenses may be adjusted appropriately based on the physical deformation of the first electroactive material.

The memory 104 may store various data for performing the operation method of an electronic device that will be described below through FIGS. 1 to 8. The memory 104 may store one or more instructions executed by the one or more processors 103. The memory 104 may be referred to as a memory and may be a volatile memory or non-volatile memory. In the memory 104, image data captured by the artificial intelligence model and the optical part 101 of the electronic device 100 may be stored.

In the present specification, the artificial intelligence model may be an artificial intelligence model for object detection. More specifically, the artificial intelligence model may be a model that has superior performance of detecting an object of a specific size. However, since it is difficult to secure image data that includes objects of various sizes, when image data in which a size of an object is corrected appropriately through a field-of-view variation is used as input data, object detection performance of the artificial intelligence model may be greatly enhanced. In other words, according to the operation method of an electronic device, it is possible to minimize an effort of securing image data that includes objects of various sizes, and it is possible to greatly alleviate dependency of object detection performance on object sizes in the artificial intelligence model. Accordingly, even when the electronic device 100 or the target object moves, the electronic device 100 may effectively detect and track the target object by using the artificial intelligence model.

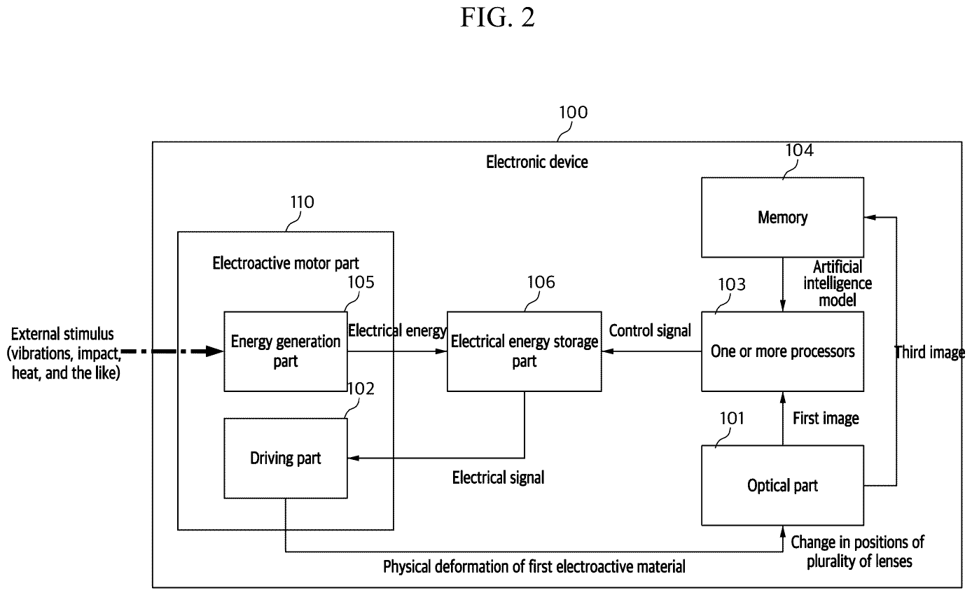

FIG. 2 is a diagram for describing an operation method of an electronic device according to an example embodiment.

According to an example embodiment, an electronic device 100 may include an optical part 101, a driving part 102, one or more processors 103, and a memory 104, and may further include an energy generation part 105 and an electric energy storage part 106.

An electroactive motor part 110 may include the driving part 102 including a first electroactive material, and the energy generation part 105 including a second electroactive material. The electroactive motor part 110 may quickly collect electrical energy by using the second electroactive material that is characterized by a fast reactive speed, and may quickly adjust a field of view of an image captured through the optical part 101 by using the first electroactive material that is characterized by a large deformation rate. In other words, by using the electroactive motor part 110 that includes different electroactive materials, the electronic device 100 may track a target object moving at a high speed in real time.

The energy generation part 105 may be a device for collecting energy required for an operation of the electronic device 100. For example, the energy generation part 105 may have a body formed based on the second electroactive material, and may collect electrical energy generated as the second electroactive material reacts to an external stimulus including vibrations, impact, and heat. In other words, without a separate power supply device, the electronic device 100 may operate only by electrical energy generated by reacting to an external stimulus, but is not limited thereto. The electronic device 100 may further include a separate power supply auxiliary device. More specifically, when collecting the electrical energy generated as the second electroactive material reacts to an external stimulus is not smoothly performed, the power supply auxiliary device may be used subsidiarily.

In the present specification, the second electroactive material may include an electroactive polymer of which a reaction time to an external stimulus is within a set time. As an example, the second electroactive material may include a ferroelectric polymer-based electroactive polymer. The second electroactive material that includes the ferroelectric polymer-based electroactive polymer may be characterized by having a fast reaction speed (for example, a few to several tens of milliseconds). As another example, the second electroactive material may be a polymer of the ferroelectric polymer-based electroactive polymer and a dielectric elastomer-based electroactive polymer, in which a proportion of the ferroelectric polymer-based electroactive polymer is higher.

Electrodes may be applied to one surface and another surface of the second electroactive material. As electric charges are collected through the electrodes, the energy generation part 105 may collect electrical energy. According to an example embodiment, the electrical energy collected in the energy generation part 105 may be represented as shown in Equation 1.

$$W = \frac{1}{2} Q V = \frac{1}{2} ( d \times σ \times A ) ( g \times σ \times {t}_{BAP} ) = \frac{1}{2} d \times g \times {σ}^{2} \times volume \qquad [ Equation 1 ]$$

Here, W denotes collected energy, Q denotes an electric charge collected through an electrode, V denotes a voltage, σ denotes additional stress, d denotes a current constant, g denotes a voltage constant, A denotes an active area of a second electroactive material structure, and t_{BAP} denotes a thickness of the second electroactive material structure.

The electric energy storage part 106 may be a device that stores electrical energy collected in the energy generation part 105. More specifically, electrical energy generated as the second electroactive material reacts to an external stimulus, including vibrations, impact, and heat, may be collected in the electric energy storage part 106.

The one or more processors 103 may perform an operation of identifying a target object in a first image captured through the optical part 101 by using an artificial intelligence model stored in the memory 104, and an operation of determining correction information. The one or more processors 103 may determine a control signal for physical deformation corresponding to correction information of the first electroactive material. More specifically, by transmitting the control signal to the electric energy storage part 106, the one or more processors 103 may control an electrical signal corresponding to the control signal to be applied to the driving part 102. The voltage, as the electrical signal based on electrical energy corresponding to the control signal stored in the electric energy storage part 106, may be applied to an electrode applied to the first electroactive material. More specifically, electrodes may be applied to one surface and another surface of the first electroactive material. As the voltage is applied, a shape of the first electroactive material may be deformed.

More specifically, according to an example embodiment, the driving part 102 may drive to change positions of a plurality of lenses when large deformation of the first electroactive material occurs as the voltage is applied. When the voltage is applied, the first electroactive material may be deformed up to several hundred of percent of its original length, depending on a magnitude of the voltage. In addition, the first electroactive material is very flexible, and thus may be deformed into various shapes. According to an example embodiment, as the voltage is applied to the first electroactive material, stress that is generated in the first electroactive material may be represented as shown in Equation 2.

$${P}_{EAP} = \frac{1}{2} {ϵ}_{r} {ϵ}_{0} {E}^{2} = \frac{1}{2} {ϵ}_{r} {{ϵ}_{0} ( \frac{{V}_{applied}}{{t}_{EAP}} )}^{2} \qquad [ Equation 2 ]$$

Here, P_{EAP} denotes stress generated in a first electroactive material structure, ϵᵣ denotes a dielectric rate (dielectric constant), ϵ₀ , denotes a vacuum dielectric rate, E denotes an applied electric field, V_{applied} denotes an applied voltage, and t_{EAP} denotes a thickness of the first electroactive material structure.

The positions of the plurality of lenses may be adjusted from a first position to a second position depending on stress generated in the first electroactive material. More specifically, as distances between the plurality of lenses change, an effective focal distance may be adjusted appropriately. According to the effective focal distance, angles of view of the plurality of lenses may be adjusted to a wide angle or a narrow angle. Accordingly, a position of the target object in the first image may be adjusted to a central position in the first image, and a size of the target object in the first image may be adjusted to a set size.

A third image may be an image obtained as the position and size of the target object in the first image are adjusted. The artificial intelligence model may be a model having superior performance of detecting an object of a set size. The third image may be used for training data of the artificial intelligence model. In other words, as the operation method of an electronic device is repeated, the object detection performance of the artificial intelligence model may be greatly enhanced.

When the electronic device 100 or the target object moves, it may be appropriate to repeatedly adjust the positions of the plurality of lenses. Accordingly, in response to a set time elapsing from a point in time at which the control signal is determined, the electronic device 100 may identify the target object in a second image captured by the optical part including the plurality of lenses corresponding to the second position. The set time may be set to effectively and appropriately track and detect the target object based on a moving speed of the electronic device 100 or the target object. Or, in response to a deviation of a size of the target object in the second image from a set range, the electronic device 100 may identify the target object in the second image captured by the optical part including the plurality of lenses corresponding to the second position. In this regard, since the electronic device 100 or the target object moves, the second image captured by the optical part 101 including the plurality of lenses corresponding to the second position may be different from the third image obtained right after the position and size of the target object in the first image are adjusted.

FIG. 3 is a diagram for describing a method of identifying a target object among a plurality of objects included in a first image according to an example embodiment.

According to an example embodiment, an electronic device 100 may identify a target object among a plurality of objects included in a first image 300 based on position information and class information of the plurality of objects. More specifically, the electronic device 100 may identify an object, among the plurality of objects, that is closest to a central position in the first image 300 while matching predefined class information as the target object.

Referring to FIG. 3, the first image 300 may include two objects of a first class indicated by circles, two objects of a second class indicated by triangles, and two objects of a third class indicated by squares. When the predefined class information indicates the second class, the electronic device 100 may identify the object closest to the central position in the first image among the two objects indicated by triangles 300 as the target object. A target object 310 positioned in (x, y) may be an object of the second class while being most adjacent to (x_{c}, y_{c}), which is the central position. According to an example embodiment, a distance between an object and the central position may be calculated using Euclidean distance. However, it is not limited thereto, and various distance calculation methods may be used.

FIG. 4 is a diagram for describing a first image including an identified target object according to an example embodiment.

According to an example embodiment, a first image 400 may be an image obtained after removing remaining objects other than the target object identified in the example of FIG. 3. However, a target object in the first image 400 may have a size that is not appropriate to be detected by an artificial intelligence model. Accordingly, an electronic device 100 may perform an operation of determining correction information that adjusts the size of the target object appropriately while moving the target object to a central position in the first image 400. This will be described in more detail with reference to FIG. 5.

FIG. 5 is a diagram for describing a third image obtained as positions of a plurality of lenses are adjusted from a first position to a second position according to an example embodiment.

According to an example embodiment, an electronic device 100 may determine correction information by using information on a position and size of an anchor box that includes a target object. Referring to FIG. 5, the information on the position of the anchor box that includes the target object may be referred to as (x, y), and the information on the size of the anchor box may be w and h. Here, w denotes a width of the anchor box, and h denotes a height of the anchor box.

According to an example embodiment, the correction information may include at least one of shift information for adjusting a position of the target object in the first images 300 and 400 and magnification information for adjusting a size of the target object in the first images 300 and 400. In addition, information on the target object may include information on the position of the target object in the first images 300 and 400 and the information on the size of the target object in the first images 300 and 400.

According to an example embodiment, the shift information may be information for adjusting the position of the target object in the first images 300 and 400 to the central positions in the first images 300 and 400. Referring to FIG. 5, the shift information may be (x_{c}-x, y_{c}-y).

According to an example embodiment, the magnification information may be information for adjusting the size of the target object in the first images 300 and 400 to a set size. More specifically, in consideration of W, which is widths of the first images 300 and 400, and H, which is heights of the first images 300 and 400, the magnification information may be information on a scale-up/scale-out ratio that enables a relatively longer one between w, which is the width of the anchor box, and h, which is the height of the anchor box, to become a 1/R size of the first images 300 and 400. FIG. 5 may be a diagram for describing an example embodiment in which w/W is greater than h/H, however, the magnification information may be similarly calculated even in another example embodiment in which w/W is smaller than h/H. Referring to FIG. 5, the magnification information, which is the scale-up/scale-out information, may be represented as shown in Equation 3.

$$S \times w = \frac{W}{R} , S = \frac{W}{R w} \qquad [ Equation 3 ]$$

Here, S denotes the magnification information. w′, which is the width of the anchor box after applying S, which is the magnification information, and h′, which is the height of the anchor box, may be represented as shown in Equation 4.

$${w}^{′} = S \times w = \frac{W}{R} , {h}^{′} = S \times h = \frac{W h}{R w} \qquad [ Equation 4 ]$$

In other words, when a control signal that allows physical deformation that corresponds to the correction information including the shift information and the magnification information to occur in a first electroactive material is determined, and when a plurality of lenses are adjusted based on the physical deformation of the first electroactive material, the position and size of the target object in the first images 300 and 400 may be adjusted appropriately. The position of the target object in the third image 500 may be adjusted to the central position, and the size of the target object may also be scaled up as much as S, which is the magnification information.

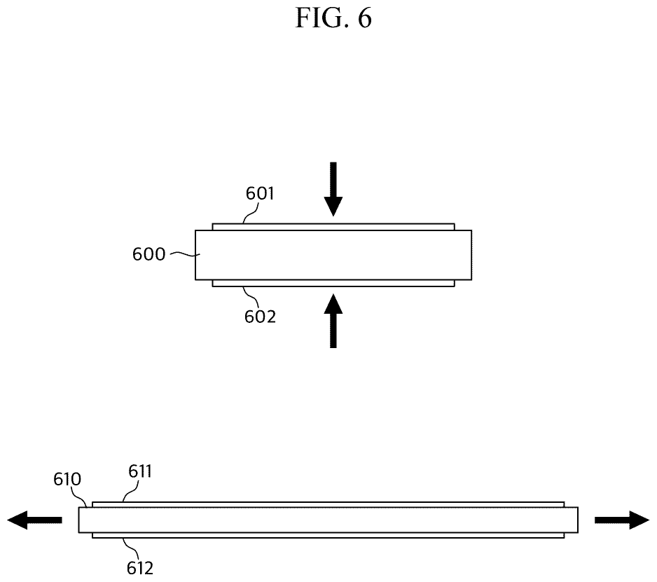

FIG. 6 is a diagram for describing physical deformation of a first electroactive material according to an example embodiment.

According to an example embodiment, a first electrode 601 may be applied to one surface of a first electroactive material 600, and a second electrode 602 may be applied to another surface of the first electroactive material 600. As represented in Equation 2, according to a voltage applied to electrodes that include the first electrode and the second electrode, P_{EAP}, which is stress generated in the first electroactive material, may be changed. The stress generated in the first electroactive material may induce compression in a thickness direction of the first electroactive material. When the first electroactive material is incompressible, an extension in a plane direction by the compression in the thickness direction may occur. When an extension rate in the plane direction is λₚ, and when a reduction rate in the thickness direction is λₜ, Equation 5 may be satisfied. Equation 5 may represent a volume preservation condition.

$${λ}_{p} \times {λ}_{t} = 1 \qquad [ Equation 5 ]$$

The first electroactive material 600 may be a first electroactive material in which the voltage applied to the first electrode 601 and the second electrode 602 is V_{applied, 1}. The first electroactive material 610 may be a first electroactive material in which the voltage applied to the first electrode 611 and the second electrode 612 is V_{applied, 2}. When V_{applied, 2} is greater than V_{applied, 1}, physical deformation extending more in the plane direction may occur in the first electroactive material 610 than the first electroactive material 600. When the physical deformation of the first electroactive material is approximated by deformation of a simple linear elastic body, physical deformation E_{EAP} may be represented as shown in Equation 6.

$${E}_{EAP} \approx \frac{p}{Y} = \frac{{ϵ}_{r} {ϵ}_{0}}{2 Y} {( \frac{{V}_{applied}}{{t}_{EAP}} )}^{2} \qquad [ Equation 6 ]$$

Here, E_{EAP} may represent the physical deformation of the first electroactive material, and Y denotes an elastic coefficient of the first electroactive material. In other words, since greater physical deformation occurs as intensity of the applied voltage is greater, physical deformation extending more in the plane direction may occur in the first electroactive material 610, to which voltage V_{applied, 2} is applied, than the first electroactive material 600.

However, according to an example embodiment, the first electroactive material is not limited to that illustrated in FIG. 6. For example, the first electroactive material may have a spring shape. Here, according to an electrical signal applied to a driving part 102, the first electroactive material may expand or contract in a specific axial direction.

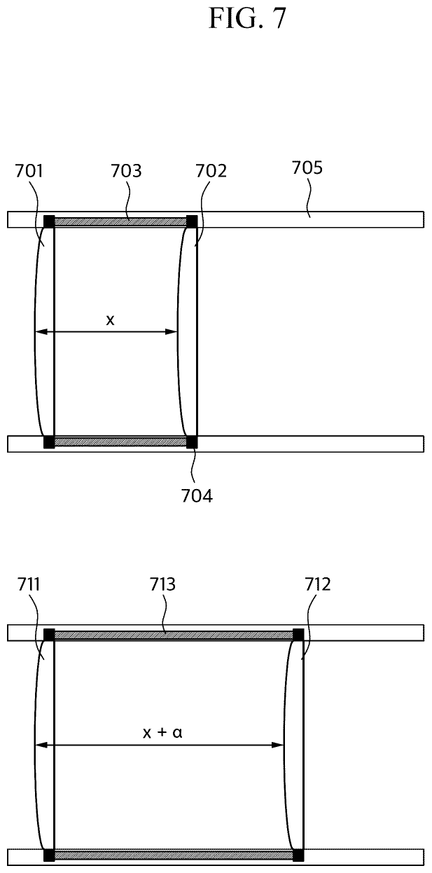

FIG. 7 is a diagram for describing an example in which distances between a plurality of lenses are changed as physical deformation occurs in a first electroactive material according to an example embodiment.

According to an example embodiment, positions of the plurality of lenses may be adjusted according to a degree of physical deformation that occurs in a first electroactive material. More specifically, as a voltage applied to the first electroactive material changes, the degree of the physical deformation of the first electroactive material may change. In addition, the positions of the plurality of lenses may be adjusted according to the degree of the physical deformation.

According to an example embodiment, the positions of the plurality of lenses, including a first lens 701 and a second lens 702, may be determined depending on a magnitude of a voltage applied to a first electroactive material 703. The first electroactive material 703 may correspond to a first electroactive material 600. When voltage V_{applied, 1} is applied to the first electroactive material 703, physical deformation corresponding to V_{applied, 1} may occur in the first electroactive material 703. A distance between the first lens 701 and the second lens 702 according to physical deformation may be determined as x. A barrel 705 included in an optical part 101 may be a fixed component, and a plurality of position sensors including a position sensor 704 may be attached to the barrel 705. An electronic device 100 may precisely control the positions of the plurality of lenses by using the plurality of position sensors to check the positions of the plurality of lenses in real time.

According to an example embodiment, a first electroactive material 713 may correspond to a first electroactive material 610. When voltage V_{applied, 2} is applied to the first electroactive material 713, physical deformation corresponding to V_{applied, 2} may occur in the first electroactive material 713. More specifically, when V_{applied, 2} is greater than V_{applied, 1}, physical deformation extending more in a plane direction may occur in the first electroactive material 713 than the first electroactive material 703. Accordingly, the distance between the first lens 701 and the second lens 702 may be determined as x+α, which is greater than x. Conversely, although it is not illustrated in FIG. 7, when V_{applied, 3}, Which is a voltage smaller than V_{applied, 1}, is applied, the distance between the first lens 701 and the second lens 702 may be determined as x−β, which is smaller than x.

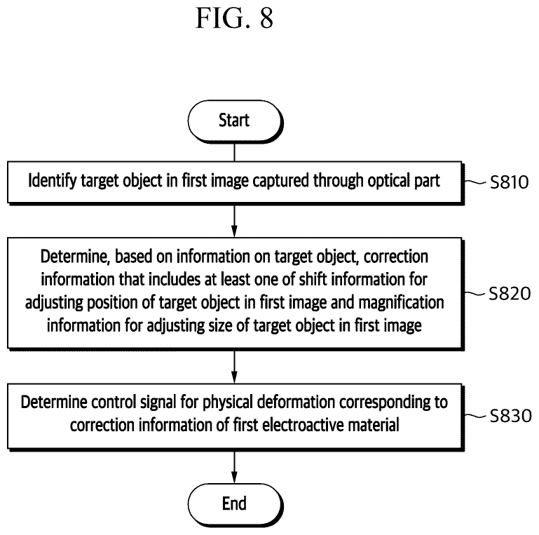

FIG. 8 is a flowchart illustrating an operation method of an electronic device according to an example embodiment.

Referring to FIG. 8, it will be understood that a portion of operations of an operation method of an electronic device 100 may be modified, substituted, or have their order changed, as long as such modifications fall within the scope clearly understood by a person skilled in the art.

In operation S810, the electronic device 100 may identify a target object in a first image captured through an optical part 101. The target object may be an object to be a target of detection by the electronic device 100.

In operation S820, the electronic device 100 may determine, based on information on the target object, correction information that includes at least one of shift information for adjusting a position of the target object in the first image and magnification information for adjusting a size of the target object in the first image. The correction information may be information for adjusting the target object to have a size for excellent detection performance by an artificial intelligence model stored in a memory 104.

In operation S830, the electronic device 100 may determine a control signal for physical deformation corresponding to the correction information of a first electroactive material. Accordingly, the physical deformation may occur in the first electroactive material. Each position of each of a plurality of lenses may be adjusted by the first electroactive material in which the physical deformation occurs.

According to an example embodiment, one or more of the following effects may be expected.

According to an example embodiment of the present specification, even when a position or size of a target object in an image captured through an optical part is changed as an electronic device or the target object moves, a plurality of lenses are adjusted appropriately through physical deformation of an electroactive material, so that the position or size of the target object in the image may be maintained consistently. In addition, by using the image, in which the position and size of the target object are maintained consistently, as training data, the performance of an artificial intelligence model for detecting a specific-sized object may be greatly enhanced.

According to an example embodiment of the present specification, since a driving part included in the electronic device includes an electroactive material, unlike a general driving part, it is possible to perform a field-of-view variation operation within a very short period of time. Accordingly, even when the electronic device or the target object moves very fast, the position or size of the target object in the image captured through an imaging part may be maintained consistently.

The effects of the invention are not limited to those described above, and other effects not explicitly described may be clearly understood by those skilled in the art from the scope of the claims.

Meanwhile, disclosed are example embodiments of the disclosure in the present specification and drawings, it should be understood that specific terms used herein are merely for the purpose of describing the technical content of the disclosure and facilitating understanding of the disclosure, and are not intended to limit the scope of the disclosure. It will be apparent to those skilled in the art that, in addition to the embodiments disclosed herein, various modifications based on the technical spirit of the disclosure may also be implemented.

An electronic device or terminal according to the above-mentioned embodiments may include a processor, a storage that stores and executes program data, a permanent storage such as a disk drive, a communication port that communicates with an external device, and a user interface device such as a touch panel, a key, and an icon. Methods implemented as software modules or algorithms may be stored in a computer-readable recording medium as computer-readable codes or program instructions executable by the processor. Here, the computer-readable recording medium may include a magnetic storage medium (e.g., a read-only memory (ROM), a random access memory (RAM), a floppy disk, a hard disk) and an optical reading medium (e.g., a compact disc read-only memory (CD-ROM), a digital versatile disc (DVD)). The computer-readable recording medium may be distributed across computer systems connected through a network, and computer-readable codes may be stored and executed in a distributed manner. The medium may be readable by a computer, stored in the storage, and executed by the processor.

The example embodiments may be represented by functional blocks and various processing steps. These functional blocks may be implemented by various numbers of hardware and/or software configurations that execute specific functions. For example, the example embodiments may adopt integrated circuit configurations such as a storage, a processor, a logic circuit, and a look-up table that may execute various functions by control of one or more microprocessors or other control devices. Similarly to that components may be executed by software programming or software components, the example embodiments may be implemented by programming or scripting languages such as C, C++, java, and assembler language, and Python including various algorithms implemented by combinations of data structures, processes, routines, or of other programming configurations. Functional aspects may be implemented by algorithms executed by one or more processors. In addition, the example embodiments may adopt the related art for electronic environment setting, signal processing, and/or data processing. The terms “mechanism”, “component”, “means”, and “configuration” may be widely used and are not limited to mechanical and physical elements. These terms may include meaning of a series of routines of software in association with the processor.

It will be apparent to those skilled in the art that various modifications and variations can be made in the example embodiments of the invention without departing from the spirit or scope of the invention. Thus, it is intended that the present invention cover the modifications and variations of this invention provided they come within the scope of the appended claims and their equivalents.

1. An electronic device comprising:
an optical part comprising a plurality of lenses;
a driving part comprising a first electroactive material;
an energy generation part configured to collect electrical energy generated as a second electroactive material reacts to an external stimulus;
one or more processors; and
a storage,
wherein the one or more processors are configured to identify a target object in a first image captured through the optical part, determine, based on information on the target object, correction information that comprises at least one of shift information for adjusting a position of the target object in the first image and magnification information for adjusting a size of the target object in the first image, and determine a control signal for physical deformation corresponding to the correction information of the first electroactive material,
wherein the plurality of lenses are adjusted based on the physical deformation,
wherein the first electroactive material comprises a dielectric elastomer-based electroactive polymer having a strain of a set value or more, and
wherein the second electroactive material comprises a ferroelectric polymer-based electroactive polymer having a reaction time to the external stimulus within a set time.

2. (canceled)

3. (canceled)

4. The electronic device of claim 1, wherein the one or more processors are configured to identify the target object among a plurality of objects included in the first image based on position information and class information of the plurality of objects.

5. The electronic device of claim 1, wherein the information on the target object comprises information on the position of the target object in the first image, and
wherein the shift information is information for adjusting the position of the target object in the first image to a central position in the first image.

6. The electronic device of claim 1, wherein the information on the target object comprises information on the size of the target object in the first image, and
wherein the magnification information is information for adjusting the size of the target object in the first image to a set size.

7. The electronic device of claim 1, further comprising an electrical energy storage part configured to store the electrical energy collected from the energy generation part,
wherein the one or more processors are configured to control, by transmitting the control signal to the electrical energy storage part, an electrical signal corresponding to the control signal to be applied to the driving part.

8. The electronic device of claim 7, wherein, as the electrical signal is applied to the driving part, a shape of the first electroactive material is deformed to correspond to a magnitude of the electrical signal, and
wherein positions of the plurality of lenses are adjusted from a first position to a second position to have a field of view corresponding to the correction information as the shape of the first electroactive material is deformed.

9. The electronic device of claim 8, wherein the one or more processors are configured to identify, in response to a set time elapsing from a point in time at which the control signal is determined, the target object in a second image captured by the optical part comprising the plurality of lenses corresponding to the second position.

10. The electronic device of claim 8, wherein, as the positions of the plurality of lenses are adjusted from the first position to the second position, the first image is changed to a third image, and
wherein the third image is used for training data of an artificial intelligence model for object detection.

11. An operation method of an electronic device that comprises an optical part comprising a plurality of lenses, a driving part comprising a first electroactive material, an energy generation part configured to collect electrical energy generated as a second electroactive material reacts to an external stimulus, one or more processors, and a storage, the method comprising:
identifying a target object in a first image captured through the optical part;
determining, based on information on the target object, correction information that comprises at least one of shift information for adjusting a position of the target object in the first image and magnification information for adjusting a size of the target object in the first image; and
determining a control signal for physical deformation corresponding to the correction information of the first electroactive material,
wherein the plurality of lenses are adjusted based on the physical deformation,
wherein the first electroactive material comprises a dielectric elastomer-based electroactive polymer having a strain of a set value or more, and
wherein the second electroactive material comprises a ferroelectric polymer-based electroactive polymer having a reaction time to the external stimulus within a set time.

12. A non-transitory computer-readable recording medium comprising a computer program for performing an operation method of an electronic device that comprises an optical part comprising a plurality of lenses, a driving part comprising a first electroactive material, an energy generation part configured to collect electrical energy generated as a second electroactive material reacts to an external stimulus, one or more processors, and a storage, the operation method comprising:
identifying a target object in a first image captured through the optical part;
determining, based on information on the target object, correction information that comprises at least one of shift information for adjusting a position of the target object in the first image and magnification information for adjusting a size of the target object in the first image; and
determining a control signal for physical deformation corresponding to the correction information of the first electroactive material,
wherein the plurality of lenses are adjusted based on the physical deformation,
wherein the first electroactive material comprises a dielectric elastomer-based electroactive polymer having a strain of a set value or more, and
wherein the second electroactive material comprises a ferroelectric polymer-based electroactive polymer having a reaction time to the external stimulus within a set time.
